(19) United States
(12) Patent Application Publication
(10) Pub. No.: US 2002/0030804 A1
(43) Pub. Date: Mar. 14, 2002

(54) Scanning device

(76) Inventors: Chuan-Yu Hsu, Hsinchu (TW); Mai Jer-Kuei, Hsinchu (TW)

Correspondence Address: Dike, Bronstein, Roberts & Cushman, Intellectual Property Patent Practice, EDWARDS & ANGELL, LLP, P.O. Box 9169, Boston, MA, 02209, US

(21) Appl. No.: 09/886,827

(22) Filed: Jun. 21, 2001

(30) Foreign Application Priority Data
Jun. 22, 2000 (TW) 089210727

(51) Int. Cl. G03B 1/00

(52) U.S. Cl. 355/133

(57) ABSTRACT

A scanning device is provided which includes a casing for a chassis to be slidably installed therein. The chassis is mounted with a circuit board having a photoelectric transforming element for performing image scanning and a plurality of switching elements for activating the photoelectric transforming element. The switching elements are capable of being cooperative with a plurality of push-keys installed on the casing, at the time the chassis is positioned at a position where the switching elements are in contact with the push-keys, allowing the switching elements to be pressed by the push-keys when the push-keys are pressed by an external force.

### BACKGROUND OF THE INVENTION

1. Field of the Invention

The present invention relates to devices, and more particularly, to a scanning device for scanning image information on a document disposed thereon.

2. Description of Related Art

FIG. 1 illustrates a simplified schematic diagram of a convention scanner, in which a rectangular body depicted by dotted lines represents a casing 100 of the scanner.

On the top side of the 100 here is fitted a transparent panel such as glass (not shown), and inside the casing 100 there is mounted a chassis 10 capable of sliding back and forth along a slide lever 9 under the parent panel, so as to scan a document or a graph placed on the transparent panel by means of a photoelectric transmitting device 12, e.g a CCD (charge coupled device) or CIS CMOS (complementary metal oxide semiconductor), As shown in FIG. 1, on the chassis 10 there is installed a circuit board 14, while the aforementioned photoelectric transforming device 12 is mounted on one side of the circuit board 14 that is enclosed in the chassis 10.

Furthermore, even though not shown in FIG. 1, the first circuit board 14 is electrically connected with a second circuit board 20 installed at the rear of the casing 100 (left in FIG. 1) by means of a wire bank is in order to receive instructions for and to send out image data obtained in the scans option through the second circuit board 20. Besides, a third circuit board 30 at the front of the casing 100 (right in FIG. 1) is also electrically conditioned with the second circuit board 20 by means of sensors 31, 32, and a wire bank 33 electrically interconnecting the connectors 31, 32. As shown in FIG. 1, a third board 30 includes a plurality of switching devices 34 thereon such as push switches, and the casing 100 has a corresponding plurality of push-keys 40 so as to allow a user to give to the scanner directions such as scanner copy, or fax directly by using the push keys 40.

Even though generally in a scanner software since at the computer end is provided for a user to give instruction to the scanner, extra push-keys 40 installed on the casing 100 provided users with operational convenience such as singe key-scan. Therefore, most of the scanners still retain the aforementioned push-keys for user's direct operation.

However, the third circuit board 30 is provided merely for tie electrical connection between the push keys 40 and the first circuit board 14 via the second circuit board 20, so as to have the photoelectric transforming device 12 perform scanning operation. As a result, the circuit board 30, tie two connectors 31 and 32, and tie wire bank 33 are additionally for the provision of the push-keys 40 for users. This not only increases the number of components but also complicates assembly procedures of tie conventional scanner. Therefore, the aforementioned conventional scanner is cost-ineffective and time-consuming to manufacture.

Furthermore, as illustrated in tie drawing, since the aforementioned wire bank 33 has to be extended from the front end to the rear end of the scanner, it is long in length. As a result, when in operational EMI (electomagnetic interference) problem will result in the wire bank 33 so that the electrical performance of the scanner is adversely affected. To prevent from incurred, EMI cores (not shown) are as required. This nevertheless increases the manufacturing cost and assembly time for the scanner.

### SUMMARY OF THE INVENTION

The primary objective of the present invention is to provide a scanning device that is cost effective to manufacture when compared to the prior art

Another objective of the present invention is to provide a scanning device that lows a saving of assembling working-hours.

In order to achieve the above and other objectives the present invention provides a scanning device including a casing, a chassis slidably mounted in the casing a circuit board installed on the chassis with a photoelectric transforming unit for perform age scanning mounted on a first side of the circuit board enclosed in the chassis and a plurality of switch unit formed on a second side of the circuit board exposed to the chassis, and a plurality of push-keys installed on the casing for being cooperative with the plurality of the switching units on the chassis sat a position that allows the trams mitts to be in contact with the push-keys.

As such, the switching units can be directly pressed by the push-keys when the push-keys are in contact with the switching units and are being pressed by a user. Therefore, the photoelectric scanning unit is activated responsive to the movement of the switching units by the push-keys, thereby no addition circuit board used to accommodate the switching units and no additional wire bank for electrically connecting the circuit board and the push-keys. This allows the scanner device of he present invention to be cost effectively manufactured and easily assembled.

### BRIEF DESCRIPTION OF DRAWINGS

The scanning device of the present invention can be fully understood by reading the following detailed description of the preferred embodiments, with reference made to the accompanying drawings wherein:

FIG. 1 is a schematic structural view of a conventional scanner;

FIG. 2 is a partially sectional view of an embodiment of the scanner device in a accordance with the present invention;

FIG. 3 is a partially sectional view of another embodiment of the scanner device in accordance with the present invention; and

FIG. 4(A) is a partially sectional view of still another embodiment of the scanner device in accordance with the present invention and FIG. 4(B) is a front view of the switching unit shown in FIG. 4(A).

### DETAILED DESCRIPTION OF PREFERRED EMBODIMENT

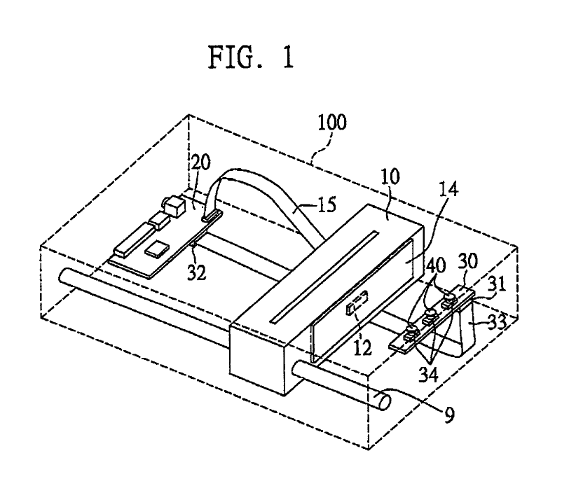

As shown in FIG. 1, in the conventional scanner, the chassis 10 is allowed to move in the casing 100 from a fist position where the chassis 10 is positioned proximate to the push-keys 40, to a second position where the chassis 10 is positioned proximate to the second circuit board 20. Besides, the push-keys 40 represent instructions for scan copy, and fax, respectively.

The basic structure of the scanner device of the present invention is the same as that illustrated in FIG. 1. Therefore, scanner components of he scanner device of this invention identical to those indicated in FIG. 1 are labeled with the same numeral references.

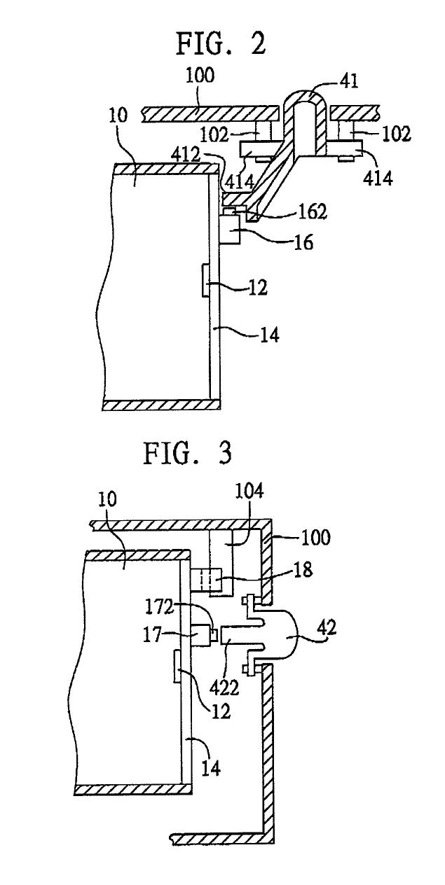

Referring to FIG. 2, the scanner device of the present invention has switching units 16 installed on a second side of the circuit board 14 that includes the photoelectric scanning unit 12 mounted on a first side of the circuit board 14. A plurality of push-keys 41 are provided on the first 100 in that each of the push-keys 41 is correspond in position to each of the switches 16. As shown in FIG. 2, when the chassis 10 is positioned at the first position, the push-keys 41 are each in contact with the switching units 16 for allowing the switching units 16 to be cooperative with the push-keys 41. Therefore, when the push-keys 41 are pressed by a user, the switch units 16 are synchronously pressed by the corresponding push-keys 41 to thereby activate tie photoelectric transforming unit 12 to perform image g,nm Atthe 1we time, the ch 10 is divtn to move from the first position to the secend position by a driviag motor (not shown), making the switching units 16 to disengage form the push-keys 41. As the association of the driving motor and the chassis 10 as well as the driving motor itself are conventional, detailed description thereto is omitted here.

As shown in FIG. 2, because the push-key 41 is installed on a top wall of the casing 100 over the chassis 10, conventional push-button switches can be used as the switching units 16. Each of the switching units 16 is formed wit a push-button 162 parallel to the plane of the circuit board 14, so a pre portion 412 that extends downwardly form the bottom of the push-key 41 can act on the push-button 162 when the push-key 41 is pressed by an exit force. Each of the push-keys 41 also has a pair of outwardly extending resilient flanges 414 that are coupled to the casing 100 by means of bolts 102 of on the casing 100.

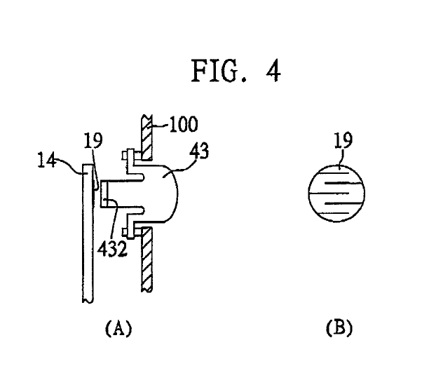

FIG. 3 shows another preferment of the present invention wherein a push-key 42 is movably mounted on a side wall of the casing 100, and a switching unit 17 in the form of a push-button switch is protruded form the circuit board 14, to be cooperative with the push-key 42. As a result a push-button 172 formed on the switching unit 17 is perpendicular to the circuit board 14. As such, when the push-key 142 is pressed by an ex force, a downwardly extending pressing portion 422 of the push-key 42 present on the push-button 172. The mounting of the push-key 42 to the casing 100 is the same as that of the push-key 41 illustrated in the above, and therefore the description thereto will hereby be omitted.

Referring to FIG. 3, on the circuit board 14 there is a provided a home sensor 18 which can detect whether the chassis 10 is positioned at first position or not. The home sensor 18 can be an optical sensor or a mechanical sensor so as to sense a positioning plate 104 integrally formed on the 100.

Furthermore, the push-key and switching this in the preferred embodiment illustrated in FIG. 3 can be of the configuration shown in FIG. 4(A). As shown in FIG. 4(A). the switching 19 are in the form of conductive cot pad (as shown in FIG. 4(B)) attached to the circuit board 14, and at the end of a push-key 43 opposing the switching unit 19 there is provided with a conductive rubber 432. As such, when the push-key 43 is press the switching device 19 is in contact with the conductive rubber 432.

The aforementioned are only exemplary preferred embodiment of the present invention. The scope of the claims as to be stated below should be accorded to the broad interpretation so as to encases vaunts modifications and similar arrangements made without violation of the basic principle and technology of the present invention.

What is claimed is:

1. A scanning device, comprising:
a casing;
a chassis slidably mounted in the casing, for being movably driven by a driving unit from a first position to a second position in the casing;
a circuit board installed on the chassis, having a first side enclosed in the chassis and mounted with a photoelectric transforming unit for performing image scanning and an opposing second side exposed to the chassis and formed with a plurality of switching units; and
a plurality of push-keys installed on the casing and for being in contact with the switching units when the chassis is positioned at the first position, so as to allow the switching units to be operatively cooperative with the push-keys.

2. The scanning device of claim 1, wherein the push-keys is capable of being pressed toward a direction parallel to the circuit board when the push-keys are installed on a top surface of the casing above the circuit board.

3. The scanning device of claim 1, wherein the push-keys is capable of being pressed toward a direction perpendicular to the circuit board when the push-keys are installed on a side surface of the casing facing the circuit board.

4. The scanning device of claim 1, wherein one portion of the push-keys are capable of being pressed toward a direction parallel to the circuit board, and another portion of the push-keys are capable of being pressed toward a direction perpendicular to the circuit board.

5. The scanning device of 1, further comprising a home sensor for detecting if the chassis is positioned at the first position.

6. The scanning device of claim 1, wherein the switching units are push-button switches.

7. The scanning device of claim 1, wherein the driving unit is a driving motor.

8. The scanning device of claim 1, wherein the photoelectric transforming unit is a CCD (Charge Coupled Device).
